(19) United States
(12) Patent Application Publication
(10) Pub. No.: US 2025/0282059 A1
(43) Pub. Date: Sep. 11, 2025

(54) Device for gripping a receptacle

(71) Applicant: Serac group, LA FERTE BERNARD (FR)

(72) Inventors: Christophe DROUIN, LA FERTE BERNARD (FR); Sylvère ODILLARD, SAINT VICTOR DE BUTHON (FR)

(21) Appl. No.: 19/064,209

(22) Filed: Feb. 26, 2025

(30) Foreign Application Priority Data
Mar. 5, 2024 (FR) FR2402208

(51) Int. Cl. B25J 15/00; B25J 9/10; B65G 61/00

(52) U.S. Cl. CPC B25J 15/0028; B25J 9/104; B65G 61/00

(57) ABSTRACT

A device for gripping a receptacle includes a first jaw and a second jaw interconnected by a sliding connection. At least one out of the first jaw and second jaw includes at least one flexible clamping flange which has a base through which there extends a rod which is mounted so that it can move in translation in the base along a longitudinal axis of the rod between an extended position and a retracted position. One end of the rod is coupled to the base by means of a first link chain and a second link chain extending on either side of the longitudinal axis of the rod, and the first link chain and the second link chain have at least one first end link and one second end link coupled to the base and to the end of the rod, respectively, along hinge axes.

The invention relates to the conveying of receptacles within an industrial production line, more particularly to a device for gripping a receptacle.

### BACKGROUND OF THE INVENTION

It is known to use a conveyor for transporting empty bottles from a blowing machine to a filling machine within an industrial production line. Conveyors generally comprise a conveying track and a plurality of transportation units which are arranged to move along said conveying track and which comprise a gripper capable of grasping a bottle.

Grippers comprising two jaws that are made of deformable materials and interconnected by a sliding connection to form a flexible clamp are known. While such grippers make it possible to grasp bottles of different sizes and shapes, they do not allow said bottles to be positioned precisely, nor do they provide sufficient hold for carrying out filling and capping operations.

Grippers comprising at least two rigid jaws that are rotatably mounted on a base and controlled by a pneumatic or electric actuator are also known. Grippers comprising two jaws that are hingedly connected around a pantograph-type structure and controlled by a pneumatic or electric actuator are also known. While these grippers allow bottles to be grasped quickly, they are particularly expensive and do not provide sufficient flexibility for grasping bottles of different sizes and shapes.

Filling and capping bottles requires a gripping device which is flexible, fast and precise but which also guarantees that the bottle is securely held.

### OBJECT OF THE INVENTION

The object of the invention is to propose a gripping device for overcoming at least some of the above-mentioned drawbacks.

### SUMMARY OF THE INVENTION

To this end, a device for gripping a receptacle is proposed, comprising a first jaw and a second jaw interconnected by a sliding connection along a translation axis to form the clamping jaws of a clamp.

At least one out of the first jaw and second jaw comprises at least one flexible clamping flange which extends in a plane parallel to the translation axis and which comprises a base through which there extends a rod which is mounted so that it can move in translation in the base along a longitudinal axis of the rod between an extended position and a retracted position.

One end of the rod is coupled to the base by means of a first link chain and a second link chain extending on either side of the longitudinal axis of the rod, the first link chain and the second link chain comprising at least one first end link and one second end link coupled to the base and to the end of the rod, respectively, along hinge axes perpendicular to the plane.

A clamping flange of this kind makes it possible to match different receptacle shapes and sizes and also to quickly provide a secure hold of the receptacle without having to use an actuator to hinge the clamping flange.

According to a particular feature, the rod is returned to its extended position by resilient return means.

In particular, the resilient return means comprise a first spring coupled to the first end link of the first link chain and to the base, and a second spring coupled to the first end link of the second link chain and to the base.

According to another particular feature, either the first jaw or the second jaw comprises two flexible clamping flanges arranged one above the other.

According to another particular feature, the first jaw and the second jaw are identical.

According to another particular feature, the other of the first jaw and the second jaw is arranged to form at least one centring V.

In particular, the centring V is rigid.

In particular, the other of the first jaw and the second jaw is arranged to form two centring Vs arranged one above the other.

The invention also relates to a transportation unit for a conveyor comprising a gripping device of this kind.

The invention also relates to a conveyor comprising at least one such transportation unit.

### BRIEF DESCRIPTION OF THE DRAWINGS

The invention will be better understood in the light of the following description, which is purely illustrative and non-limiting and should be read with reference to the accompanying drawings, in which:

FIG. 1 is a perspective view showing a conveyor comprising a transportation unit according to a particular embodiment of the invention;

FIG. 2A is a first perspective view of the transportation unit shown in FIG. 1;

FIG. 2B is a second perspective view of the transportation unit shown in FIG. 1;

FIG. 2C is an identical view to FIG. 2A in which the transportation unit is carrying a receptacle;

FIG. 3A is a plan view of the transportation unit shown in FIG. 1, arranged on a straight portion of the conveying track;

FIG. 3B is an identical view to FIG. 3A in which the transportation unit is carrying a receptacle;

FIG. 3C is an identical view to FIG. 3A, arranged on a curved portion of the conveying track;

FIG. 4 is a plan view of a variant of the transportation unit shown in FIG. 1.

### DETAILED DESCRIPTION OF THE INVENTION

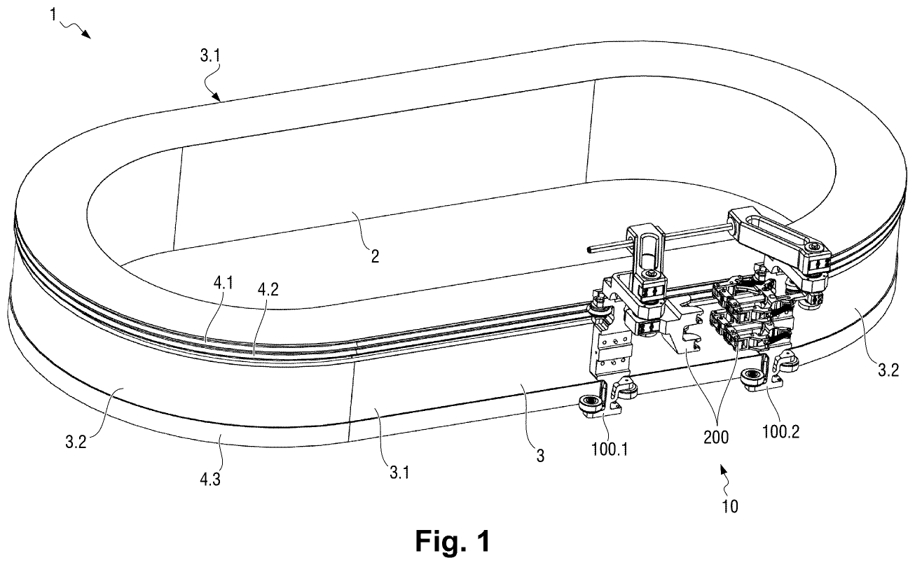

With reference to FIG. 1, a receptacle conveyor 1 according to a particular embodiment of the invention comprises conveying track 2 and a plurality of transportation units 10 capable of moving along said conveying track 2 by means of electromagnetic currents. For reasons of clarity, only one transportation unit 10 has been shown but the transportation units 10 are all identical here.

The conveying track 2 comprises an outer periphery 3 defining a height of the conveying track 2. The outer periphery 3 of the conveying track 2 extends substantially vertically and comprises two parallel planar surfaces 3.1 interconnected by two semi-cylindrical surfaces 3.2 so as to define a movement path of the transportation unit 10 in a closed loop.

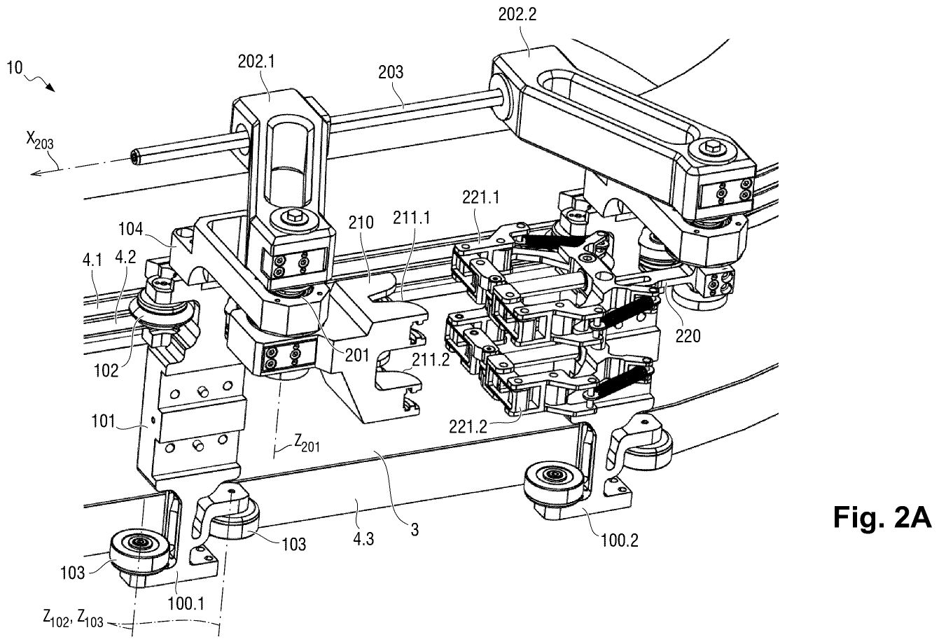

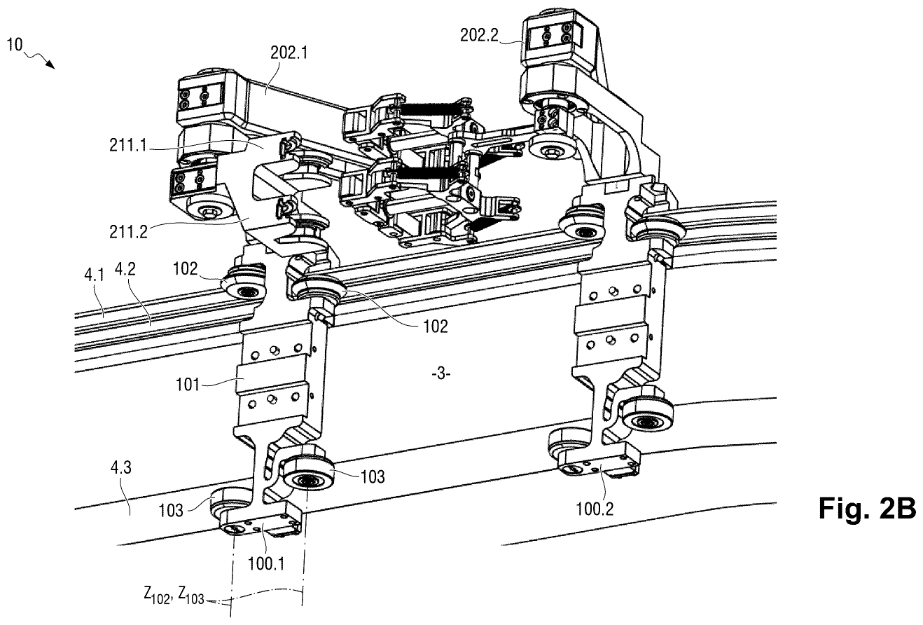

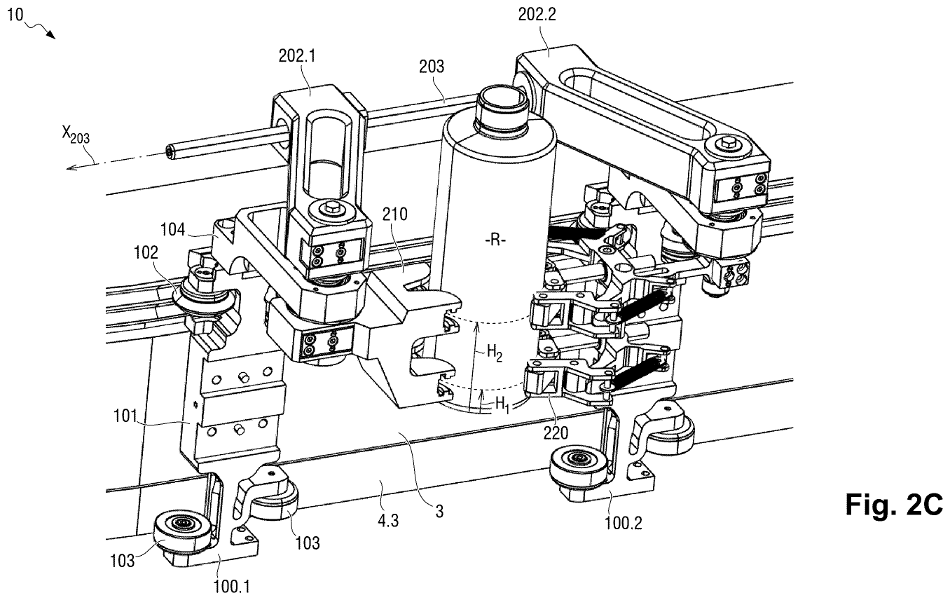

With reference to FIGS. 2A-2C, the transportation unit 10 comprises a first shuttle 100.1, a second shuttle 100.2 and a gripping device 200 borne by the first shuttle 100.1 and the second shuttle 100.2.

In this case, the first shuttle 100.1 and the second shuttle 100.2 are identical and are arranged to move horizontally, independently of each other, along the outer periphery 3 of the conveying track 2.

The first and second shuttles 100.1, 100.2 each comprise a body 101 extending substantially vertically, facing the outer periphery 3 of the conveying track 2. The body 101 includes an upper portion bearing two first castors 102, and a lower portion bearing two second castors 103.

The first castors 102 are mounted on the body 101 so that they can rotate about first vertical axes Z₁₀₂ and are shaped to roll in grooves 4.1, 4.2 formed in the upper part of the outer periphery 3 of the conveying track 2. The grooves 4.1, 4.2 each extend in a first horizontal plane and define a planar movement path for the first and second 10 shuttles 100.1, 100.2.

The second castors 103 are mounted on the body 101 so that they can rotate about second vertical axes Z₁₀₃ and are shaped to roll on a planar rolling surface 4.3 formed in the lower part of the outer periphery 3 of the conveying track 2. The rolling surface 4.3 extends in a second horizontal plane, and in this case the second rotational axes Z₁₀₃ of the second castors 103 are coaxial with the first rotational axes Z₁₀₂ of the first castors 102.

It is understood that the first shuttle 100.1 and the second shuttle 100.2 are arranged to roll on the outer periphery 3 of the conveying track 2.

The first shuttle 100.1 and the second shuttle 100.2 are held and moved, independently of each other, along the 25 outer periphery 3 of the conveying track 2 by means of an electromagnetic system that is known per se; the position, speed and acceleration of the first shuttle 100.1 are managed independently of the position, speed and acceleration of the second shuttle 100.2.

The first and second shuttles 100.1, 100.2 also each include a substantially rectilinear support 104 that extends generally horizontally from an upper end of the body 101. The support 104 has a proximal end rigidly attached to the upper end of the body 101, and a distal end having a hole in which a hinge shaft 201 is rotatably mounted along a vertical axis Z₂₀₁. It is understood that the support 104 is stationary with respect to the body 101. In this case, the hinge shaft 201 has a lower end and an upper end extending on either side of the support 104.

The gripping device 200 forms a clamp and comprises:
the hinge shafts 201 borne by the first shuttle 100.1 and the second shuttle 100.2;
a first jaw 210 rigidly attached to the lower end of the hinge shaft 201 borne by the first shuttle 100.1;
a second jaw 220 rigidly attached to the lower end of the hinge shaft 201 borne by the second shuttle 100.2;
a first arm 202.1 having a proximal end rigidly attached to the upper end of the hinge shaft 201 borne by the first shuttle 100.1;
a second arm 202.2 having a proximal end rigidly attached to the upper end of the hinge shaft 201 borne by the second shuttle 100.2; and
a holding rod 203 facing the first and second jaws 110, 120, the rod 103 having a first end rigidly attached to a distal end of the second arm 202.2, and a second end, on the opposite side to the first end, mounted so that it can move in translation in a hole formed at a distal end of the first arm 202.1, along a longitudinal axis X₂₀₃ of the rod 203.

It should be noted that the longitudinal axis X₂₀₃ of the rod 203 is orthogonal to the rotational axes Z₂₀₁ of the hinge shafts 201.

It is understood that the first jaw 210 and the first arm 202.1 are stationary with respect to the hinge shaft 201 borne by the first shuttle 100.1 (in other words that the first jaw 210 is stationary with respect to the first arm 202.1), and that the second jaw 220, the second arm 202.2 and the rod 203 are stationary with respect to the hinge shaft 201 borne by the second shuttle 100.2 (in other words that the second jaw 220 is stationary with respect to the second arm 202.2).

It is also understood that the first jaw 210 and the second jaw 220 form the clamping jaws of the clamp and can move in translation along the longitudinal axis X₂₀₃ of the rod 203 which defines a sliding connection.

It is also understood that the first jaw 210 cannot rotate relative to the second jaw 120.

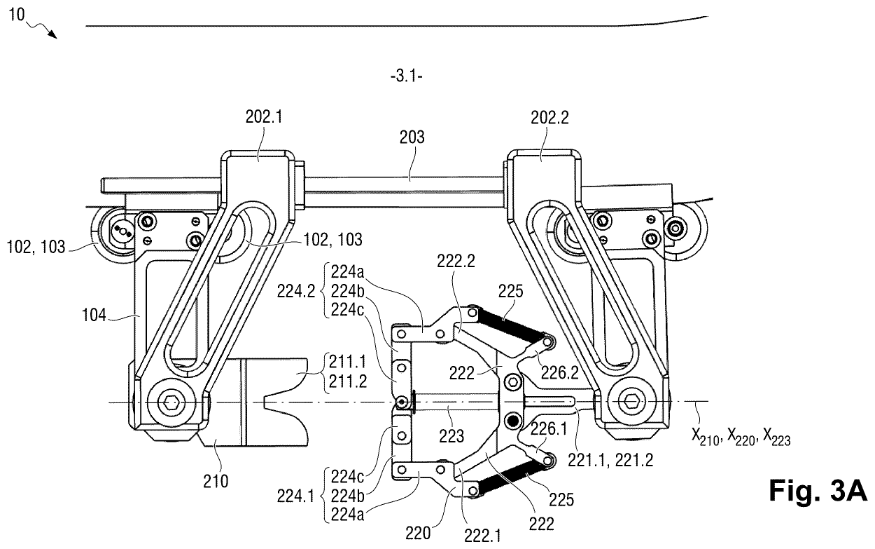

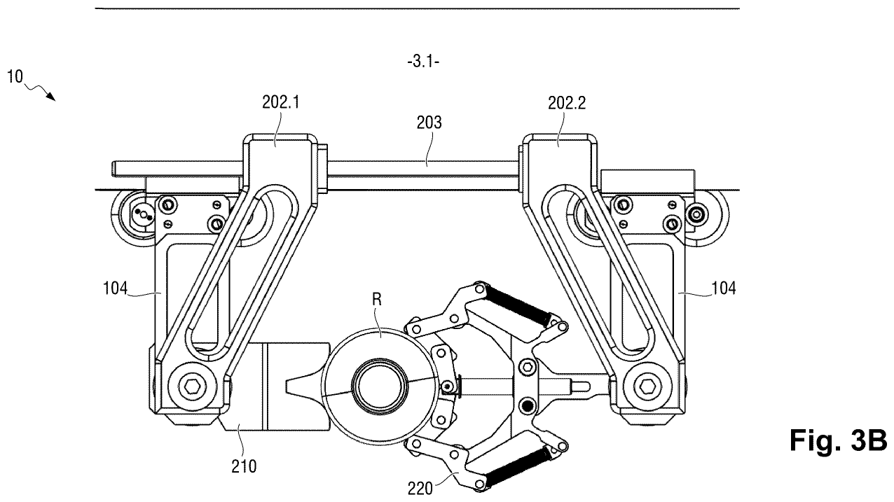

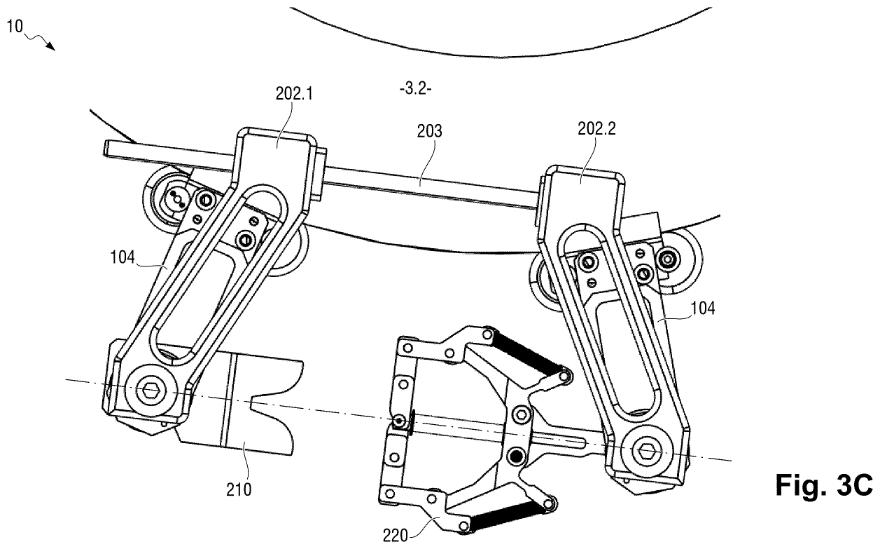

The first jaw 210 projects horizontally from the hinge shaft 201 borne by the first shuttle 100.1, along a first clamping axis X₂₁₀ that is perpendicular to the rotational axis Z₂₀₁ of said hinge shaft 201 and parallel to the longitudinal axis X₂₀₃ of the rod 203 (FIG. 3A).

The first jaw 210 comprises a free end that faces the second jaw 220 and that is arranged to form a first centring V 211.1 and a second centring V 211.2 arranged one above the other. The first centring V 211.1 and the second centring V 211.2 extend, respectively, in a first horizontal plane defining a first clamping height H₁ of the receptacle R and in a second horizontal plane defining a second clamping height H₂ of the receptacle R (FIG. 2C). In this case, the first centring V 211.1 and the second centring V 211.2 are identical and have the same vertical plane of symmetry, defined here by the rotational axes Z₂₀₁ of the hinge shafts 201. The shape and dimensions of the first and second centring Vs 211.1, 211.2 are adapted to the shape and dimensions of the receptacle R to be transported.

The first centring V 211.1 and the second centring V 211.2 are referred to as being rigid in that they are not deformed when the receptacle R is clamped as set out below.

The second jaw 220 projects horizontally from the hinge shaft 201 borne by the first shuttle 10.2, along a second clamping axis X₂₂₀ that is perpendicular to the rotational axis Z₂₀₁ of said hinge shaft 201 and to the longitudinal axis X₂₀₃ of the rod 203 (FIG. 3A). In this case, the second clamping axis X₁₂₀ is coaxial with the first clamping axis X₁₁₀.

The second jaw 220 comprises a free end that faces the first jaw 210 and that is arranged to form a first clamping flange 221.1 and a second clamping flange 221.2 arranged one above the other. The first clamping flange 221.1 and the second clamping flange 221.2 extend, respectively, in the first horizontal plane defining the first clamping height Hi of the receptacle R and in the second horizontal plane defining the second clamping height He of the receptacle R. In this case, the first clamping flange 221.1 and the second clamping flange 221.2 are identical and have the same vertical plane of symmetry, defined here, as with the first and second centring Vs 211.1, 211.2, by the rotational axes Z₂₀₁ of the hinge shafts 201.

With reference to FIG. 3A, the first and second clamping flanges 221.1, 221.2 each comprise a stationary base 222, generally in the shape of a circular arc, through the middle of which there extends a rod 223 for controlling the deformation of the first and second clamping flanges 221.1, 221.2. The rod 223 has a longitudinal axis X₂₂₃ that is coaxial with the clamping axis X₂₂₀ of the second jaw 220, and is mounted so that it can move in translation in the base 222 along its longitudinal axis X₂₂₃ between an extended position, in which a distal end of the rod 223 is remote from the base 222, and a retracted position, in which the distal end of the rod 223 is close to said base 222.

The distal end of the rod 223 is coupled to a first end 222.1 and to a second end 222.2 of the base 222 by means of a first link chain 224.1 and a second link chain 224.2, respectively. In this case, the first link chain 224.1 and the second link chain 224.2 are identical and comprise three interconnected links, namely a first link 224a, a second link 224b and a third link 224c. The first link 224a is coupled to the base 224 along a first vertical axis, the second link 224b is coupled to the first link 224a along a second vertical axis, and the third link 224c is coupled to the second link 224b along a third vertical axis and to the distal end of the rod 223 along a fourth vertical axis. A free end of the first link 224a of the first and second link chains 224.1, 224.2 is also coupled, by means of a helical tension spring 225, to a free end of an attachment tab 226.1, 226.2 projecting radially outwards from the base 222.

It is understood that the links 224a, 224b, 224c of the first link chain 224.1 form, together with the base 222 and the rod 223, a first horizontal loop, and that the links 224a, 224b, 224c of the second link chain 224.2 form, together with the base 222 and the rod 223, a second horizontal loop identical to the first loop.

It is thus also understood that:
when the rod 223 is in the extended position, the links 224a, 224b, 224c of the first link chain 224.1 are remote from the links 224a, 224b, 224c of the second link chain 224.2; and
when the rod 223 is in the retracted position, the links 224a, 224b, 224c of the first link chain 224.1 are remote from the links 224a, 224b, 224c of the second link chain 224.2; and
the rod 223 is returned to the extended position by the springs 225.

In this case, the dimensions of the links 224a, 224b, 224c of the first and second link chains 224.1, 224.2 are selected such that:
when the rod 223 is in the extended position, the second and third links 123b, 123c of the first and second link chains 123.1, 123.2 are substantially horizontally aligned along an axis that is perpendicular to the longitudinal axis X₂₂₃ of the rod 223 and therefore perpendicular to the clamping axis X₂₂₀; and
when the rod 223 is in the retracted position, the second and third links 224b, 224c of the first and second link chains 224.1, 224.2 form a recess suitable for matching the shape of the receptacle R to be transported.

It should be noted that the movement of the rod 223 is not controlled by an actuator; the movement of the rod 223 results solely from a sufficient axial force exerted on the distal end of said rod 223.

The first clamping flange 221.1 and the second clamping flange 221.2 are referred to as being deformable or flexible in that the links 224a, 224b, 224c of the first and second link chains 224.1, 224.2 are made to move when the receptacle R is clamped as set out below.

The operation of the transportation unit 10 and its gripping device 200 will now be described in detail.

In this case, the receptacle R intended to be transported is a bottle having, in a manner known per se, a lower part of a substantially constant diameter, an upper part that narrows upwards and a neck that forms an upper end of the bottle.

First, the first shuttle 100.1 and the second shuttle 100.2 of the transportation unit 10 are locked along the conveying track 2 so as to be far enough apart from each other to accommodate the bottle R in a vertical position between the first jaw 210 and the second jaw 220.

Second, the bottle R is fed in and held in a vertical position, for example by means of a transfer robot, between the first jaw 210 and the second jaw 220 such that the longitudinal axis of the bottle R is substantially perpendicular to the first and second clamping axes X₂₁₀, X₂₂₀ of said first and second jaws 210, 220.

The first shuttle 100.1 and the second shuttle 100.2 are then moved towards each other so that the distance between the first jaw 110 and the second jaw decreases until said first jaw 210 and said second jaw 220 are in contact with a first lateral surface and a second lateral surface of the bottle R at a first height H₁ and a second height H₂ of said bottle R, respectively. The bottle R is then accommodated in the centring Vs 211.1, 211.2 of the first jaw 210.

As the second shuttle 100.2 is brought ever closer to the first shuttle 100.1, the bottle R exerts a compression force on the sliding rods 223 of the second jaw 220, said force urging said rods 223 from the extended position to the retracted position. The second and third links 224b, 224c of the first and second link chains 224.1, 224.2 then substantially match the shape of the second lateral surface of the bottle R.

The second shuttle 100.2 is moved further towards the first shuttle 100.1 until the clamping forces exerted by the first and second jaws 210, 220 on the lateral surfaces of the bottle R are sufficient to hold said bottle R in position between the first and second jaws 210, 220 without the help of the transfer robot.

The bottle R is then released by the transfer robot, and the movements of the first shuttle 100.1 and second shuttle 100.2 are controlled and synchronised so that both the space between them and the clamping forces exerted on the bottle R by the first and second jaws 210, 220 remain substantially constant throughout the movement of the first and second shuttles 100.1, 100.2 along the conveying track 2. The bottle R is then made to move along the conveying track 2.

To release the bottle R from the clamping forces exerted by the first and second jaws 210, 220 in order to remove it from the conveyor 1, the movements of the first and second shuttles 100.1, 100.2 merely have to be controlled so as to move the shuttles away from each other.

It should be noted that the sliding connection formed by the rod 203 between the first jaw 210 and the second jaw 220 makes it possible to hold said first jaw 210 and said second jaw 220 axially facing each other, regardless of the angular position of the first and second shuttles 100.1, 100.2.

Thus, regardless of whether the first shuttle 100.1 and/or the second shuttle 100.2 are rolling on the planar surfaces 3.1 (FIGS. 3A-3B) or the semi-cylindrical surfaces 3.2 (FIG. 3C) of the conveying track 2, the contact regions between the bottle R and the first and second jaws 210, 220 remain identical throughout the movement of the transportation unit 10 along the conveying track 2, such that the risk of the bottle R falling while it is being transported is particularly limited.

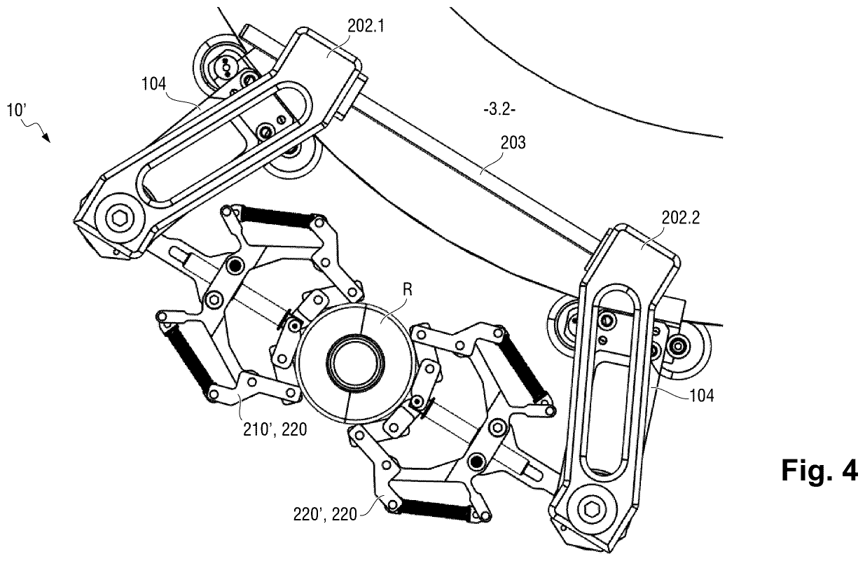

FIG. 4 shows a transportation unit 10′ that is merely a variant of the transportation unit 10. The transportation unit 10′ differs from the transportation unit 10 in that the gripping device 200′ of the transportation unit 10′ comprises a first jaw 210′ and a second jaw 220′ identical to the first jaw 210′. Both the first jaw 110′ and the second jaw 120′ of the transportation unit 10′ are identical to the second, deformable jaw 220 of the transportation unit 10.

The transportation unit 10′ is operated in the same way as the transportation unit 10, except that the bottle R is clamped by the first jaw 210′ and the second jaw 220′ being deformed. The sliding connection formed by the rod 203 between the first jaw 210′ and the second jaw 220′ makes it possible, as in the transportation unit 10, to hold the first jaw 210′ and the second jaw 220′ axially facing each other, regardless of the angular position of the first and second shuttles 100.1, 100.2.

Another variant of the transportation unit 10 (not shown) involves replacing the second, deformable jaw 220 with a jaw identical to the first, rigid jaw 210.

This other variant of the transportation unit 10 is operated in the same way as the transportation unit 10, except that the bottle R is clamped without the first and second jaws being deformed. The sliding connection formed by the rod 203 between the first jaw and the second jaw makes it possible, as in the transportation unit 10, to hold the first jaw and the second jaw axially facing each other, regardless of the angular position of the first and second shuttles 100.1, 100.2.

It goes without saying that the invention is not limited to the described embodiment but covers any variant falling under the scope of the invention.

Although in this case the first jaw 210 and the second jaw 220 comprise two centring Vs 211.1, 211.2 and two clamping flanges 221.1, 221.2 to form two clamping levels, the first jaw 210 and/or the second jaw 220 may comprise one or more than two centring Vs and one or more than two clamping flanges so as to form one or more than two clamping levels.

The springs 225 can be replaced with any resilient return means capable of returning the sliding rod 223 to its extended position. For example, a spring may be mounted around the rod between the distal end of the rod and the base.

The sliding rod 223 may be replaced with any means for ensuring a sliding connection between the first jaw 210, 210′ and the second jaw 220, 220′. The dimensions and shape of the different elements of the transportation unit 10, 10′ can be adapted to the dimensions and shape of the receptacles R to be transported, in particular those of the arms 202.1, 202.2, of the centring Vs 211.1, 211.2, of the links 224a, 224b, 224c, etc.

Although in this case the link chains 224.1, 224.2 comprise three links 224a, 224b, 224c, they may comprise a number of links that is less than or greater than three.

The first jaw 210 and the second jaw 220 can be attached to the first arm 202.1 and the second arm 202.2, respectively.

The first arm 202.1 and the second arm 202.2 can be attached to the first jaw 210 and the second jaw 220, respectively.

The first shuttle 100.1 may be different from the second shuttle 100.2.

The first arm 202.1 may be different from the second arm 202.2.

Although in this case the clamping axis X₂₁₀, X₂₂₀ of the first and second jaws 210, 210′, 220, 220′ is perpendicular to the rotational axes Z₂₀₁ of the hinge shafts 201, it may more generally be orthogonal to said rotational axes Z₂₀₁.

Although in this case the centring Vs 211.1, 211.2 of the first jaw 210 and the clamping flanges 221.1, 221.2 of the second jaw 220 extend in a horizontal plane, they can extend in a plane that forms a non-zero angle with the horizontal plane so as to clamp a bottle R whose longitudinal axis is not vertical.

Although in this case the conveying track 2 extends in a horizontal plane, it may extend in a slanted plane that forms a non-zero angle with the horizontal plane.

Such slants of the conveying track 2 and of the first and second jaws 210, 210′, 220, 220′ may in particular make it possible to have a different slant of the longitudinal axis of the bottle R along the planar surface 3.1 and also of the planar surface 3.2 of the conveying track 2. For example, when the conveying track 2 is slanted by 45° about its longitudinal axis and the first and second jaws 210, 210′, 220, 220′ are also slanted by 45° with respect to the plane in which the conveying track 2 extends, the longitudinal axis of the bottle R is horizontal on one of the planar surfaces 3.1, 3.2 of the conveying track 2 and vertical on the other of the planar surfaces 3.1, 3.2.

The position of the sliding connection with respect to the first and second jaws 210, 210′, 220, 220′ can be different from that shown. By way of example, the sliding connection may be arranged above or below the first and second jaws 210, 210′, 220, 220′.

To improve the hold of the bottle R by means of the first and second jaws 210, 220, the centring Vs 211.1, 211.2 and the clamping flanges 221.1, 221.2 may be covered, at least in part, with an elastomer material so as to provide contact surfaces having a high coefficient of friction with the bottle R. For example, an elastomer profile may be inserted on the inner periphery of the centring Vs 211.1, 211.2, and an elastomer pellet may be clipped onto an outer surface of the second links 224b of the first and second link chains 224.1, 224.2.

The dimensions and shape of the different elements forming the gripping device 200, 200′ can be adapted to the dimensions and shape of different ranges of receptacles R to be transported.

1. A device for gripping a receptacle, comprising a first jaw and a second jaw interconnected by a sliding connection along a translation axis to form the clamping jaws of a clamp,
at least one out of the first jaw and second jaw comprising at least one flexible clamping flange which extends in a plane parallel to the translation axis and comprises a base through which there extends a rod which is mounted so that it can move in translation in the base along a longitudinal axis of the rod between an extended position and a retracted position,
one end of the rod being coupled to the base by means of a first link chain and a second link chain extending on either side of the longitudinal axis of the rod, the first link chain and the second link chain comprising at least one first end link and one second end link coupled to the base and to the end of the rod, respectively, along hinge axes perpendicular to the plane.

2. The device according to claim 1, wherein the rod is returned to its extended position by resilient return means.

3. The device according to claim 2, wherein the resilient return means comprise a first spring coupled to the first end link of the first link chain (224.1) and to the base, and a second spring coupled to the first end link of the second link chain and to the base.

4. The device according to claim 1, wherein either the first jaw or the second jaw comprises two flexible clamping flanges arranged one above the other.

5. The device according to claim 1, wherein the first jaw and the second jaw are identical.

6. The device according to claim 1, wherein the other of the first jaw and the second jaw is arranged to form at least one centring V.

7. The device according to claim 6, wherein the centring V is rigid.

8. The device according to claim 6, wherein the other of the first jaw and the second jaw is arranged to form two centring Vs arranged one above the other.

9. A transportation unit for a conveyor, comprising the device according to claim 1.

10. A conveyor comprising the transportation unit according to claim 9.
